(19) United States
(12) Patent Application Publication
(10) Pub. No.: US 2005/0186404 A1
(43) Pub. Date: Aug. 25, 2005

(54) Etched polycarbonate films

(76) Inventors: Guoping Mao, Woodbury (IS); Rui Yang, Austin, TX (US); John C. Schultz, Afton, MN (US)

Correspondence Address: 3M INNOVATIVE PROPERTIES COMPANY, PO BOX 33427, ST. PAUL, MN, 55133-3427, US

(21) Appl. No.: 10/784,398

(22) Filed: Feb. 23, 2004

(51) Int. Cl. B60R 13/00

(52) U.S. Cl. 428/209

(57) ABSTRACT

Disclosed herein is a composition for etching a polycarbonate film comprising an alkali metal salt and an amine solubilizer. Also disclosed is a method for etching polycarbonate films with the etchant and an article containing the etched film. The article is useful for, e.g., flexible circuits and carrier tapes.

### FIELD

The invention relates to chemical etching of polycarbonate films.

### BACKGROUND

An etched copper or printed conductive circuit pattern on a polymer film base may be referred to as a flexible circuit or flexible printed wiring board. As the name suggests, flexible circuitry can move, bend and twist without damaging the conductors to permit conformity to different shapes and unique package sizes. Originally designed to replace bulky wiring harnesses, flexible circuitry is often the only solution for the miniaturization and movement needed for current, cutting-edge electronic assemblies. Thin, lightweight and ideal for complicated devices, flexible circuit design solutions range from single-sided conductive paths to complex, multilayer three-dimensional packages. A multilayer flexible circuit is a combination of two or more layers of single or double-sided flexible circuits laminated together and processed with laser drilling and plating to form plated through-holes. This creates conductive paths between the various layers without having to use multiple soldering operations.

Commonly used dielectric film base materials for flexible electronic packaging include polyimide, polyethylene terephthalate (PET), random-fiber aramid, liquid crystal polymer (LCP) and polyvinyl chloride (PVC). Changes in electronic device design create the need for new materials with properties surpassing the electrical performance and processing capabilities of the substrates listed previously. For example, a lower dielectric constant allows faster electrical signal transfer, good thermal performance facilitates cooling of the package, a higher glass transition or melting temperature improves package performance at higher temperature, and lower moisture absorption allows signal and data processing at higher frequencies.

Polyimide film is a commonly used substrate for flexible circuits that fulfil the requirements of complex, cutting-edge electronic assemblies. The film has excellent properties such as thermal stability and low dielectric constant, but represents a limiting factor to additional gain in the speed or frequency at which electronic components may operate. A major drawback to further progress using polyimide film relates to the way in which polyimide absorbs moisture to levels that interfere with high frequency device performance. Higher frequency operation requires the identification or development of substrate materials with less susceptibility to moisture absorption.

### SUMMARY

One aspect of the present invention provides a composition comprising: an aqueous solution for etching polycarbonate at a temperature from about 50° C. to about 120° C. comprising from about 30 wt. % to about 55 wt. % of an alkali metal salt; and from about 10 wt. % to about 35 wt. % of a solubilizer dissolved in said solution.

Another aspect of the present invention provides an article comprising: a flexible circuit comprising a polycarbonate film having through-holes and related shaped voids formed therein using an etchant composition comprising: an aqueous solution for etching polycarbonate at a temperature from about 50° C. to about 120° C. comprising from about 30 wt. % to about 55 wt. % of an alkali metal salt; and from about 10 wt. % to about 35 wt. % of a solubilizer dissolved in said solution.

Another aspect of the present invention provides a process comprising: providing a polycarbonate film; contacting said polycarbonate film with an aqueous solution for etching polycarbonate at a temperature from about 50° C. to about 120° C., said aqueous solution comprising from about 30 wt. % to about 55 wt. % of an alkali metal salt; and from about 10 wt. % to about 35 wt. % of a solubilizer dissolved in said solution.

Another aspect of the present invention provides an article comprising a dielectric film comprising a polycarbonate selected from the group consisting of substituted and unsubstituted polycarbonates, polycarbonate blends, and polycarbonate copolymers, the dielectric film including at least one etched recessed region.

An advantage of at least one embodiment of the present invention is that polycarbonate has low water absorption and dielectric loss making it a suitable substrate material for flexible circuit substrates.

Another advantage of at least one embodiment of the present invention is that polycarbonate film is less expensive than polyimide film. This can be important in making flexible circuits and carrier tapes for electronic devices, especially for applications that require thicker films.

### BRIEF DESCRIPTION OF FIGURES

FIGS. 1a to 1d are optical digital images of an etched polycarbonate of the present invention.

FIG. 2 is an optical digital image of a cross-section of the etched polycarbonate of FIG. 1b.

As used herein all amounts included as percentages refer to weight percent of a designated component.

### DETAILED DESCRIPTION

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

The present invention provides dielectric films as substrates for composite flexible circuits that typically include a flexible dielectric substrate film and copper conductive traces. (Conductive traces may also be gold, nickel or silver.) Specific flexible circuit applications include, lap top computers, personal digital assistants, cell phones, calculators, cameras, plasma televisions, and any device that has a display with an interface that bends or folds.

One of the key benefits of flexible circuits is their application as connectors in small electronic devices such as portable electronics where there is only limited space for connector routing. It will be appreciated that reduction in thickness of flexible circuits or portions of flexible circuits will lead to greater circuit flexibility. This increases versatility in the use of flexible circuits particularly if the reduction in thickness of the dielectric substrate allows the circuits to be folded with minimum stress in the region of the fold. A key advantage of flexible circuits is its effective use where space for device interconnection is very limited. Reduced dielectric film thickness allows flexible circuits to bend or fold at relatively sharp angles associated with stacked memory chips. Selectively thinned portions of flexible circuits may be designed to produce stacked structures, which require the dielectric film to bend conformably around interconnected electronic components.

The present invention provides a method for controllable chemical etching of polycarbonate films with an etchant solution containing a solubilizer to provide a flexible circuits having unsupported leads (also known as cantilevered leads), through-holes and vias with angled sidewalls, and other shaped voids as well as thinned or recessed regions. The present invention also allows change in the contour of through holes, vias and blind vias depending upon the concentration of solubilizer in the etchant and the temperature of etching.

One aspect of the present invention provides a film substrate for flexible circuits capable of operating at higher frequencies than currently available flex circuit substrates, particularly polyimide films such as those available under the tradename KAPTON from E.I. duPont de Nemours and Company, Wilmington, Del. and those available under the tradename APICAL from Kaneka Corporation, Kita-ku Osaka, Japan. Attainment of higher frequency performance, in response to the demand for faster electronic devices, results from the present teachings of methods for processing polycarbonates that were once considered to be relatively intractable. Characteristics of polycarbonate films include electrical insulation, moisture absorption less than 0.5% at saturation, a dielectric constant not to exceed 3.5 over the functional frequency range of 1 kHz to 45 GHz, better chemical resistance when compared to polyimide, lower modulus may enable more flexible circuits, and optical clarity.

Polycarbonates have a lower water absorption and a lower dielectric dissipation factor than polyimide, which are very important properties for applications at high frequency (GHz), such as for wireless communication or microwave devices.

The following Table 1 shows the different properties of common types of polyimide (PI), Liquid Crystal Polymer (LCP), and polycarbonate (PC).

TABLE 1

| Property | PI* | LCP** | PC*** | Test Method |
|---|---|---|---|---|
| Modulus (kpsi) | 800 | 700 | 300 | ASTM D882, 64T |
| Elongation (%) | 35 | 16 | 100-150 | ASTM D882, 64T |
| Prop. Tear | 13 | 15.4 | 30-55 | ASTM D1922-00A |
| (gm/mil) | | | | |
| Tensile | 50 | 15 | 9 | ASTM D882, 64T |
| strength | | | | |
| (kpsi) | | | | |
| Water | 2.4 | 0.1 | 0.4 | ASTM D570, 63 |
| absorption | | | | |
| (%) | | | | |
| Tg (deg. C.) | >350 | 300-350 | 150-200 | |
| CTE (ppm/ | 14 | 18 | 49-70 | ASTM D696, 44 |
| deg. C.) | | | | |
| Dielectric | 6 | 5.9 | 1.7 | ASTM D149 |
| strength | | | | |
| (kV/mil) | | | | |
| Dielectric | 3.3 | 3.0 | 3.0 | ASTM D150 |
| constant | | | | |
| Dissipation | 0.005 | 0.003 | 0.001 | ASTM D150 |
| factor | | | | |

***Property values of film are from GE Structured Products data sheets.
**LCP type = an aromatic polyester with rigid-rod molecular structures
*KAPTON E film

While polyimide and polycarbonate films may be etched using solutions of potassium hydroxide or sodium hydroxide alone, the polycarbonate etch rate is so slow that only the surface of the film can be effectively etched. Etching capabilities and methods to produce flexible printed circuits having polycarbonate substrates with voids and/or selectively formed indented regions have not been previously disclosed. Until now, low-cost patterning of the polycarbonate film has been a key issue that prevented polycarbonate films from being applied in high volume applications. However, as is disclosed and taught herein, polycarbonates can be readily etched when a solubilizer is combined with highly alkaline aqueous etchant solutions that comprise, for example, water soluble salts of alkali metals and ammonia.

Etching of films to introduce precisely-shaped voids, recesses and other regions of controlled thickness requires the use of a film that does not swell in the presence of alkaline etchant solutions. Swelling changes the thickness of the film and may cause localized delamination of resist. This can lead to loss of control of etched film thickness, shallow via sidewall slopes, and irregular shaped features due to etchant migration into the delaminated areas. Controlled etching of films, according to the present invention, is most successful with substantially non-swelling polymers. “Substantially non-swelling” refers to a film that swells by such an insignificant amount when exposed to an alkaline etchant as to not hinder the thickness-reducing action of the etching process. For example, when exposed to some etchant solutions, some polyimide will swell to such an extent that their thickness cannot be effectively controlled in reduction. Examples of suitable polycarbonate films, include substituted and unsubstituted polycarbonates, polycarbonate blends such as polycarbonate/aliphatic polyester blends, including the blends available under the tradename XYLEX from GE Plastics, Pittsfield, Mass., polycarbonate/polyethyleneterephthalate (PC/PET) blends, polycarbonate/polybutyleneterephthalate (PC/PBT) blends, and polycarbonate/poly(ethylene 2,6-naphthalate) (PC/PEN) blends, and any other blend of polycacoarbonate with a thermoplastic resin; and polycarbonate copolymers such as polycarbonate/polyethyleneterephthalate (PC/PET), polycarbonate/polyetherimide (PC/PEI), and the like. Another type of material suitable for use in the present invention is a polycarbonate laminate. Such a laminate may have at least two different polycarbonate layers adjacent to each other or may have at least one polycarbonate layer adjacent to a thermoplastic material layer (e.g., LEXAN GS125DL which is a polycarbonate/polyvinyl fluoride laminate from GE Plastics). Polycarbonate materials may also be filled with carbon black, silica, alumina and the like or they may contain additives such as flame retardants, UV stabilizers, pigment and the like.

Water soluble salts suitable for use in the present invention include, for example, potassium hydroxide (KOH), sodium hydroxide (NaOH), substituted ammonium hydroxides, such as tetramethylammonium hydroxide and ammonium hydroxide or mixtures thereof. Useful alkaline etchants include aqueous solutions of alkali metal salts including alkali metal hydroxides, particularly potassium hydroxide, and their mixtures with amines, as described in U.S. Pat. No. 6,403,211 B1 to etch LCP films. Useful concentrations of the etchant solutions vary depending upon the thickness of the polycarbonate film to be etched, as well as the type and thickness of the mask chosen such as a metal mask or a photoresist. Typical useful concentrations of a suitable salt range in one embodiment from about 30 wt. % to 55 wt. %, and in another embodiment from about 40 wt. % to about 50 wt. %. Typical useful concentrations of a suitable solubilizer range in one embodiment from about 10 wt. % to about 35 wt. %, and in another embodiment from about 15 wt. % to about 30 wt. %. The use of KOH with a solubilizer is preferred for producing a highly alkaline solution since these KOH-containing etchants provide optimally etched features in the shortest amount of time. The etching solution is generally at a temperature of from about 50° C. (122° F.) to about 120° C. (248° F.) preferably from about 70° C. (160° F.) to about 95° C. (200° F.) during etching.

Typically the solubilizer in the etchant solution is an amine compound preferably an alkanolamine. The etchant solution, including the amine solubilizer, according to the present invention works most effectively within the above-referenced percentage ranges. This suggests that there may be a dual mechanism at work for etching polycarbonates, i.e., the amine acts as a solubilizer for the polycarbonate most effectively within a limited range of concentrations of alkali metal salt in aqueous solution. Discovery of this most effective range of etchant solutions allows the manufacture of flexible printed circuits based upon polycarbonates having finely structured features previously unattainable using standard methods of drilling, punching and laser ablation.

Solubilizers for etchant solutions according to the present invention may be selected from the group consisting of amines including ethylene diamine, propylene diamine, and alkanolamines such as ethanolamine, propanolamine, and the like. Under the conditions of etching, unmasked areas of a polycarbonate film substrate become soluble by action of the solubilizer in the presence of a sufficiently concentrated aqueous alkaline solution of e.g. an alkali metal salt. The time required for etching depends upon the type and thickness of polycarbonate film to be etched, the composition of the etching solution, the etch temperature, spray pressure, and the desired depth of the etched region. Examples of etch rates for various types of polycarbonate films are shown in Table 3 and range from about 1.2 to about 26.0 μm/minute, when etched from one side of the film.

The dependence of etch rates on polycarbonate type and etchant solution concentration can be used advantageously to make a desired article. For example, a polycarbonate film having a patterned layer of photoresist could be exposed to a solution having a particular etchant concentration to achieve uniform depth etching of the exposed areas. Subsequently, different areas could be exposed, or some of the already exposed areas could be covered, then the polycarbonate film could be exposed to an etchant solution having a different etchant concentration to achieve different depths of etching. Alternatively, polycarbonate films could be made of different types of polycarbonate, in different regions, that are etched at different rates when exposed to the same etchant solution. In another embodiment, a polycarbonate laminate having its outer layer made of different polycarbonate materials with different etch rates could be exposed to an etchant solution to obtain etched features having different depths on each side of the film. This could allow areas of the article to be etched to different depths in a single step. Alternatively a laminate may be used that is a made up of a polycarbonate layer and thermoplastic material such as polyvinylfluoride (PVF). The PVF is a non-etchable material which will serve as an etch stop when etching through areas of the polycarbonate. With these embodiments, complex three-dimensional shapes may be etched into thick polycarbonate films (e.g., to make carrier pocket tapes for electronic components).

The present invention also allows change in the contour of through holes, vias and blind vias depending upon the concentration of solubilizer in the etchant and the temperature of etching. Sidewall angle ranges will typically be about 35 to about 75° angle depending on etchant composition, temperature and feature depth. The side-wall angle also changes with alkali metal hydroxide concentration in the etchant solution, such that over the concentration range of from about 35 wt. % KOH to about 55 wt. % KOH the angle of the side-wall changes from about 25° to about 55°. Modification of the angle of the side-wall is not possible using drilling, punching or laser ablation. In these latter cases, the walls of through holes are substantially parallel.

Optionally an alcohol, such as ethylene glycol or a ketone, such as methylethyl ketone (MEK), methyl isobutyl ketone (MIBK), may also be added to change the etchant concentration of the composition.

The present invention may also be used to produce flexible circuits having recessed, or thinned regions. Composite circuit durability, in terms of flex cycles, can depend upon circuit thickness and other material properties. Conventional handling techniques for the manufacture of composite circuits work best with dielectric film substrates at least 25 μm thick. The thickness of the dielectric film substrate can affect the level of difficulty associated with flex circuit processing and manufacture. If the film web is less than about 25 μm thick problems with material handling lead to difficulties in consistent manufacture of circuit structures. For example, films of uniform thickness less than 25 μm tend to irreversibly stretch or otherwise distort during the multi-step process of flexible circuit production. This problem may be reduced using substrates according to the present invention that have indented regions of controlled depth to provide localized areas having a film thickness as low as 5 μm. Typically the substrates are in the form of dielectric films having selectively thinned regions to satisfy the specific functional needs of devices for which the circuits are designed. Apart from the thinned regions the substrate film can maintain its original thickness to thereby retain dimensional stability and desirable film processing characteristics.

Another benefit of producing flexible circuits including recessed, or thinned regions is the improvement in web handling during processing to make advanced circuit structures without incurring excessive manufacturing costs. The same web handling techniques may be used for dielectric films having recessed regions as would be used for films of the same but uniform thickness. For example, flexible circuits according to the present invention can use standard dielectric film 25 μm or 50 μm thick. This allows implementation of conventional web handling for forming flexible printed circuits.

For advanced applications, thicker films may be desirable while maintaining the flexibility of the resulting structure. Polycarbonate films of about 25 μm to about 300 μm thick may be used in conjunction with the current invention.

The formation of recessed or thin regions, unsupported leads, through holes and other circuit features in the polycarbonate film typically requires protection of portions of the polymeric film using a mask of a photo-crosslinked negative acting, aqueous processible photoresist. During the etching process the photoresist preferably exhibits substantially no swelling or delamination from the polycarbonate polymer film.

Negative photoresists suitable for use with polycarbonates according to the present invention include negative acting, aqueous developable, photopolymer compositions such as those disclosed in U.S. Pat. Nos. 3,469,982; 3,448,098, 3,867,153; and 3,526,504. Such photoresists include at least a polymer matrix including crosslinkable monomers and a photoinitiator. Polymers typically used in photoresists include copolymers of methyl methacrylate, ethyl acrylate and acrylic acid, copolymers of styrene and maleic anhydride isobutyl ester and the like. Crosslinkable monomers may be multiacrylates such as trimethylol propane triacrylate.

Commercially available aqueous base, e.g., sodium carbonate developable, negative acting photoresists employed according to the present invention include polymethyl-methacrylates photoresist materials such as those available under the trade designation RISTON from E.I. duPont de Nemours and Co., e.g., RISTON 4720. Other useful examples include AP850 available from LeaRonal, Inc., Freeport, N.Y., and PHOTEC HU350 available from Hitachi Chemical Co. Ltd. Dry film photoresist compositions under the tradename AQUA MER are available from MacDermid, Waterbury, Conn. There are several series of AQUA MER photoresists including the “SF” and “CF” series with SF120, SF125, and CF2.0 being representative of these materials. A metal mask may be used in the place of the photoresist.

According to an aspect of the present invention, the polycarbonate dielectric film may be selectively chemically etched at several stages in the flexible circuit manufacturing process. Introduction of an etching step early in the production sequence can be used to thin only selected areas of the film while leaving the bulk of the film at its original thickness. Alternatively, thinning of selected areas of the film later in the flexible circuit manufacturing process can have the benefit of introducing other circuit features before altering film thickness. Regardless of when selective substrate thinning occurs in the process, film-handling characteristics remain similar to those associated with the production of conventional flex circuits.

The manufacture of flexible circuits according to the present invention comprises the step of etching, which may be used in conjunction with various known pre-etching and post-etching procedures. The sequence of such procedures may be varied as desired for the particular application. A typical additive sequence of steps may be described as follows:

Aqueous processible photoresists are laminated over both sides of a substrate comprising polycarbonate film with a thin copper side, using standard laminating techniques. Typically, the substrate has a polymeric film layer of from about 25 μm to about 300 μm, with the copper layer being from about 1 to about 5 μm thick. Alternatively, a thin metal layer may be deposited onto a surface of the polycarbonate film using sputtering, plating or a combination thereof.

The thickness of the photoresist is from about 10 μm to about 50 μm. Upon imagewise exposure of both sides of the photoresist to ultraviolet light or the like, through a mask, the exposed portions of the photoresist become insoluble by crosslinking. The resist is then developed, by removal of unexposed polymer with a dilute aqueous solution, e.g., a 0.5-1.5% sodium carbonate solution, until desired patterns are obtained on both sides of the laminate. The copper side of the laminate is then further plated to desired thickness. Chemical etching of the polycarbonate film then proceeds by placing the laminate in a bath of etchant solution, as previously described, at a temperature of from about 50° C. to about 120° C. to etch away portions of the polycarbonate polymer not covered by the crosslinked resist. This exposes certain areas of the original thin copper layer. The resist is then stripped from both sides of the laminate in a 2-5% solution of an alkali metal hydroxide at from about 25° C. to about 80° C., preferably from about 25° C. to about 60° C. Subsequently, exposed portions of the original thin copper layer are etched using an etchant that does not harm the polycarbonate film, e.g., PERMA ETCH, available from Electrochemicals, Inc.

In an alternate substractive process, the aqueous processible photoresists are again laminated onto both sides of a substrate having a polymer film side and a copper side, using standard laminating techniques. The substrate consists of a polymeric film layer about 25 μm to about 300 μm thick with the copper layer being from about 5 μm to about 40 μm thick. The photoresist is then exposed on both sides to ultraviolet light or the like, through a suitable mask, crosslinking the exposed portions of the resist. The image is then developed with a dilute aqueous solution until desired patterns are obtained on both sides of the laminate. The copper layer is then etched to obtain circuitry, and portions of the polymeric layer thus become exposed. An additional layer of aqueous photoresist is then laminated over the first resist on the copper side and crosslinked by flood exposure to a radiation source in order to protect exposed polymeric film surface (on the copper side) from further etching. Areas of the polymeric film (on the film side) not covered by the crosslinked resist are then etched with the etchant solution containing an alkali metal salt and solubilizer at a temperature of from about 70° C. to about 120° C., and the photoresists are then stripped from both sides with a dilute basic solution, as previously described.

It is possible to introduce regions of controlled thickness into the dielectric film of the flexible circuit using controlled chemical etching either before or after the etching of through holes and related voids that completely removes dielectric polymer materials as required to introduce conductive pathways through the circuit film. The step of introducing standard voids in a printed circuit typically occurs about mid-way through the circuit manufacturing process. It is convenient to complete film etching in approximately the same time frame by including one step for etching all the way through the substrate and a second etching step for etching recessed regions of controlled depth. This may be accomplished by suitable use of photoresist, crosslinked to a selected pattern by exposure to ultraviolet radiation. Upon development, removal of photoresist reveals areas of dielectric film that will be etched to introduce recessed regions.

Alternatively, recessed regions may be introduced into the polymer film as an additional step after completing other features of the flexible circuit. The additional step requires lamination of photoresist to both sides of the flexible circuit followed by exposure to crosslink the photoresist according to a selected pattern. Development of the photoresist, using the dilute solution of alkali metal carbonate described previously, exposes areas of the dielectric film that will be etched to controlled depths to produce indentations and associated thinned regions of film. After allowing sufficient time to etch recesses of desired depth into the dielectric substrate of the flexible circuit, the protective crosslinked photoresist is stripped as before, and the resulting circuit, including selectively thinned regions, is rinsed clean.

The process steps described above may be conducted as a batch process using individual steps or in automated fashion using equipment designed to transport a web material through the process sequence from a supply roll to a wind-up roll, which collects mass produced circuits that include selectively thinned regions and indentations of controlled depth in the polymer film. Automated processing uses a web handling device that has a variety of processing stations for applying, exposing and developing photoresist coatings, as well as etching and plating the metallic parts and etching the polymer film of the starting metal to polymer laminate. Etching stations include a number of spray bars with jet nozzles that spray etchant on the moving web to etch those parts of the web not protected by crosslinked photoresist.

To create finished products such as flexible circuits, interconnect bonding tape for “TAB” (tape automated bonding) processes, flexible circuits, and the like, conventional processing may be used to add multiple layers and plate areas of copper with gold, tin, or nickel and the like as required for reliable device interconnection.

### EXAMPLES

The following examples are meant to be illustrative and are not intended to limit the scope of the invention, which is expressed solely by the claims.

TABLE 2
Polycarbonate Films

| Material | | | Film | Available |
|---|---|---|---|---|
| tradename | | Chemical composition | Thickness | from |
| A1 | LEXAN | Polycarbonate | 132 μm | GE Plastics |
| | T2F DD | (smooth/Matte finish) | | (Pittsfield Ma) |
| | 112 | | | |
| A2 | LEXAN | Polycarbonate | 260 μm | GE Plastics |
| | T2FDD | (smooth/Matte finish) | | |
| | 112 | | | |
| B | LEXAN | Polycarbonate | 254 μm | GE Plastics |
| | T2F OQ | (optically clear) | | |
| | 112 | | | |
| C | LEXAN | Polycarbonate with flame | 128 μm | GE Plastics |
| | FR83 116 | retardant | | |
| D | XYLEX | PC and aliphatic polyester | 125 μm | GE Plastics |
| | D7010MC | blends | | |
| E | XYLEX | PC and aliphatic polyester | 165 μm | GE Plastics |
| | D5010MC | blends | | |
| F | XYLEX | PC and aliphatic polyester | 164 μm | GE Plastics |
| | D56 | blends | | |
| G | LEXAN | Polycarbonate | 265 μm | GE Plastics |
| | 8B25 | (filled with carbon black) | | |
| H | Zelux | Polycarbonate | 50 μm | Westlake |
| | Natural | (Smooth/fine matte finish) | | Plastics |
| | film | | | Company |
| | | | | (Lenni, PA) |
| I | Makrofol | Polycarbonate | 150 μm | Bayer |
| | DPF 5014 | (velvet/very fine matte | | Plastics Div. |
| | | finish) | | (Pittsburgh, |
| | | | | PA) |

### Example 1-5 and Comparative Example 1C

For this series of examples, different etchant solutions were used to etch different types of polycarbonate films.

For Examples 1, 3-5 and 1C, the films were subjected to two-sided etching. In other words, no coatings or resists were applied to either side of the film, so that both sides were exposed to the etchant. To determine etching speed, a small film sample (about 1 cm×about 1 cm) was cut and immersed in the etchant solution. This resulted in the sample film being etched on both sides. Etching speed (for one side) was then determined by dividing in half the reduced thickness by the etching time.

For Example 2, the films were subjected to one-sided etching. A dry aqueous processible photoresists was laminated over both sides of the polycarbonate film materials. One side of the resist was flood-exposed and the other side was exposed under a patterned mask. The exposed portions of the photoresist became insoluble by crosslinking. The resist was then developed by removal of the unexposed polymer with a dilute aqueous 0.5-1.5% sodium carbonate solution, resulting in a polycarbonate film with a solid layer of resist on one side and a patterned layer of resist on the other side. The measured etch speeds for the single exposed sides are shown below in Table 3.

All etching experiments were carried out in a beaker, without stirring, using a water bath at 85° C. unless noted otherwise. The etching results for polycarbonate films are summarized in Table 3. The etchant compositions are shown in Table 3 as the ratio of KOH to solubilizer (ethanolamine) with the balance of the composition being water unless otherwise specified. For example, Ex. 1 shows ‘45/20’ in the etchant column, which indicates an etchant composition of 45 wt. % of KOH, 20 wt. % of ethanolamine, and the remainder is water. The designations of “A” through “I” correspond to the polycarbonate films designated as A through I in Table 2 above.

TABLE 3
Summary of polycarbonate (PC) etching results
Polyimide Film Type

| | | A1 | A2 | B | C | D | E | F | G | H | I |
|---|---|---|---|---|---|---|---|---|---|---|---|
| Ex. | Etchant | Single side etching speed (μm/min) | | | | | | | | | |
| 1 | 45/20 | 23.0 | | 20 | 15.3 | 11.0 | 2.0 | 1.2 | — | — | — |
| 2 | 42/21*† | — | 26.0 | — | — | — | — | — | — | 14.7 | 19 |
| 3 | 40/20 | 15.6 | | 14.1 | 9.0 | 7.1 | 1.3 | 1.2 | 17.0 | — | 11.9 |
| 4 | 36/28 | 15.0 | | 14.8 | 10.0 | 7.9 | 1.6 | 1.5 | — | — | — |
| 5 | 33/33 | 11.5 | | 11.1 | 7.6 | 5.0 | 1.8 | 1.7 | — | — | — |
| 1C | 45/0 | 2.5 | | 2.8 | 1.2 | 1.0 | 0.2 | 0.034 | — | — | — |

*Etch temperature was about 92° C.
†Titration results showed an actual concentration of 41.8 wt % KOH and 20.9 wt % ethanolamine.

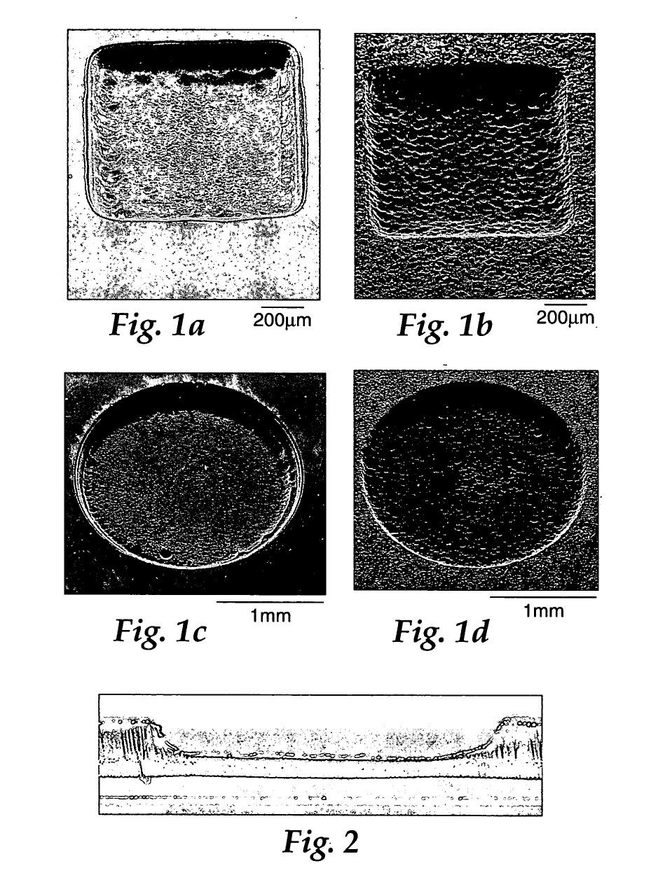

Optical digital images were taken of LEXAN T2F DD 112 films, prepared as described above for Example 2 and subjected to the etchant solution of Example 2 for 5 minutes at about 92° C. The original thickness of the film is about 260 μm and the etched depths are about 100 μm. The images are shown in FIGS. 1a to 1d and 2. FIGS. 1a and 1c show square and circular patterns, respectively, etched into the smooth side of the film. FIGS. 1b and 1d show the same square and circular patterns, respectively, etched into the matte side of the film. FIG. 2 is a cross-section of FIG. 1b, showing that the sidewalls have angles of about 45° and the etched depth is about 100 μm.

It will be appreciated by those of skill in the art that, in light of the present disclosure, changes may be made to the embodiments disclosed herein without departing from the spirit and scope of the present invention.

1. A composition comprising:
an aqueous solution for etching polycarbonate at a temperature from about 50° C. to about 120° C. comprising
from about 30 wt. % to about 55 wt. % of an alkali metal salt; and
from about 10 wt. % to about 35 wt. % of a solubilizer dissolved in said solution.

2. A composition according to claim 1 containing from about 40 wt. % to about 50 wt. % of said alkali metal salt.

3. A composition according to claim 1 containing from about 15 wt. % to about 30 wt. % of said solubilizer.

4. A composition according to claim 1 wherein said alkali metal salt is selected from the group consisting of sodium hydroxide and potassium hydroxide.

5. A composition according to claim 1 wherein said solubilizer is an amine.

6. A composition according to claim 1 wherein said solubilizer is ethanolamine.

7. An article comprising:
a flexible circuit comprising a polycarbonate film having through-holes and related shaped voids formed therein using an etchant composition comprising:
an aqueous solution for etching polycarbonate at a temperature from about 50° C. to about 120° C. comprising
from about 30 wt. % to about 55 wt. % of an alkali metal salt; and
from about 10 wt. % to about 35 wt. % of a solubilizer dissolved in said solution.

8. An article according to claim 7 including at least one unsupported cantilevered lead.

9. An article according to claim 7 including at least one through hole having non-parallel angled sidewalls.

10. A process comprising:
providing a polycarbonate film;
contacting said polycarbonate film with an aqueous solution for etching polycarbonate at a temperature from about 50° C. to about 120° C., said aqueous solution comprising
from about 30 wt % to about 55 wt. % of an alkali metal salt; and
from about 10 wt. % to about 35 wt. % of a solubilizer dissolved in said solution.

11. A process according to claim 10 wherein said aqueous solution comprises from about 40 wt. % to about 50 wt. % of said alkali metal salt.

12. A process according to claim 10 wherein said aqueous solution comprises from about 15 wt. % to about 30 wt. % of said solubilizer.

13. A process according to claim 10 wherein said alkali metal salt is selected from the group consisting of sodium hydroxide and potassium hydroxide.

14. A process according to claim 10 wherein said solubilizer is an amine.

15. A process according to claim 10 wherein said solubilizer is ethanolamine.

16. A process according to claim 10 wherein said polycarbonate film selected from the group consisting of substituted and unsubstituted polycarbonates, polycarbonate blends, and polycarbonate copolymers.

17. A process according to claim 10 wherein the polycarbonate film comprises at least two different polycarbonates having etch rates different from each other such that when the polycarbonate film is contacted with the aqueous solution the different polycarbonates are etched to different depths.

18. An article comprising a carrier pocket tape comprising a dielectric film comprising a polycarbonate selected from the group consisting of substituted and unsubstituted polycarbonates, polycarbonate blends, and polycarbonate copolymers, said dielectric film including at least one etched recessed region.

19. An article according to claim 18 wherein the dielectric film has a thickness of from about 25 μm to about 300 μm.

20. An article according to claim 18 wherein the thickness of the recessed region is reduced to less than about 25 μm.

21. An article according to claim 18 having a plurality of recesses at least two of which are etched to different depths.

22. An article according to claim 21 wherein at least two of the plurality of recesses etched to different depths are located in different regions, which different regions comprise different polycarbonates.

23. An article according to claim 18 comprising a polycarbonate film laminated to a different type of polycarbonate film or a thermoplastic film.
